(19) United States
(12) Patent Application Publication
(10) Pub. No.: US 2002/0125354 A1
(43) Pub. Date: Sep. 12, 2002

(54) Reciprocating, electric waste disposal apparatus

(76) Inventor: Ronald E. Jeffress, Draper, UT (US)

Correspondence Address: Garron M. Hobson, THORPE, NORTH & WESTERN, L.L.P., P.O. Box 1219, Sandy, UT, 84091-1219, US

(21) Appl. No.: 09/802,019

(22) Filed: Mar. 8, 2001

(51) Int. Cl. B02C 23/36

(52) U.S. Cl. 241/46.013

(57) ABSTRACT

A waste disposal apparatus includes an electric motor to reciprocally pivot a pivoting cutter that is pivotally disposed adjacent a stationary cutter. Each cutter having a plurality of spaced apart teeth, formed on arms extending radially from a hub, which intermesh as the pivoting cutter pivots. The cutters each have at least one tooth with an edge which passes adjacent the other as the pivoting cutter pivots, each edge being angled towards the other in a direction of rotation configured to concentrate force at a single point along the edges as the edges pass one another. The motor can be disposed at a side of the cutters, and off a longitudinal axis which extends between an inlet and an outlet. The motor can be disposed at an elevation above a lowermost cutter, and/or above the outlet of a housing containing the cutters. The motor can engage a perimeter of the pivoting cutter, and may have a gear interface.

### BACKGROUND OF THE INVENTION

1. Field of the Invention

The present invention relates generally to a waste disposal unit. More particularly, the present invention relates to a waste disposal unit with a cutter configuration driven in a reciprocal manner by an electric motor.

2. Related Art

Waste disposal units disposed under sinks have become commonplace. The waste disposal unit cuts or shreds waste, such as table scraps, so that the waste may pass through pipes of a house plumbing system without clogging the pipes. The disposal units provide the convenience of simply washing waste directly into the sink without having to first wipe the waste into a trash receptacle or having to later clear the waste from a drain in the sink. Disposal units are typically mounted under the sink between the drain in the bottom of the sink and the pipes or drain line of the plumbing system. In addition, such disposal units typically have a commuting rotor coupled to an electric motor to cut the waste as it passes through the units.

Despite the conveniences provided by these waste disposal units, there are several disadvantages, one of which is the high speed of the cutters or rotor. Typical disposal units have electric motors that are configured to rotate at high speeds of approximately 8,000 revolutions per minute. The high speed of the electric motor often generates considerable noise. In addition, the high speed of the electric motor, and thus the cutters or rotor, can cause the waste to be flung outwardly in a radial direction away from the cutters, rather than passing through the cutters.

Another disadvantage of electric motors is the need for electrical wiring to operate the motor. Because of this, the devices are difficult to install and pose a danger of coupling an electric source to the water and plumbing system due to the orientation of the electrical carrying components to the drip path of water. Another disadvantage is the relatively low starting torque of the electric motors. Waste initially disposed in the unit may stall the motor. Thus, the motor may burn out or pose a danger of injury as a user reaches into the unit to remove the clogged waste. If an overload switch is installed and is activated, it must be reset, and it is often located in an inaccessible location.

The nature of the commonly used electric motor and the use conditions result in a very high failure rate, estimated by some to be eighty percent (estimated 4.2 million units per year) of the installed units each year. With the type of rotor or cutters normally used for electrical waste disposal units, it is possible for fairly large particles to pass through the disposer and accumulate in a waste pipe bend, possibly causing ultimate blockage of the drain, particularly if insufficient flush water is used.

In addition, the waste outlet in electrically powered waste disposal units is typically horizontal in orientation, such that the flow of waste and water is vertically downward from an inlet, and then horizontal through the outlet forming a right angle. Thus, this right angle configuration looses the assistance of gravity and depends on flushing by water conservation/centrifugal force.

Furthermore, the motor of the electrically powered waste disposal unit is typically connected directly to the rotor, and disposed directly below the waste inlet. Such a motor configuration locates the electric motor in the natural path of water that may leak from installation joints or internal leaks that develop from operating wear.

Another disadvantage is the configuration or shape of the cutters or teeth. The cutters or teeth often meet with blunt or straight edges or faces. Because of the blade configuration, waste is more likely to become lodged in between cutters and jam the unit. In addition, the unit requires a large motor to develop sufficient torque to cut the waste with the blunt configuration of the cutters. Thus, the units may be inefficient because they require an oversized motor.

Water powered waste disposal units have been developed that are noted for their quiet operation, and capability of dealing with most any waste food. For example, U.S. Pat. Nos. 3,700,178, issued Oct. 24, 1972, to Verley, and U.S. Pat. No. 4,082,229, issued Apr. 4, 1978, to Boosman, disclose water powered waste disposal units. The units have a housing defining an annular chamber around the unit. A reciprocating drive piston is slidingly disposed in the chamber and is coupled to a pivoting cutter in the housing. A valve alternately directs pressurized water into the annular chamber on opposite sides of the drive piston to drive the piston, and thus the cutter, in a rotating motion.

Water powered waste disposal units have been developed that are capable of efficient operation at normal dynamic water pressure of approximately 30 pounds-per-square-inch (psi) or higher. In areas where water pressure falls below 30 psi, however, such water powered units may fail to perform adequately or not function at all. Performance also can be reduced when other water related activities occur simultaneously to water driven waste disposal operation. Another disadvantage of the water powered units is the degree of dimensional tolerance control required in their manufacture. Excessive variations in the unit dimensions may result in clearances and leaks, which may result in the pressure losses that render the unit inefficient, or even inoperative. Another disadvantage is that servo controllers are susceptible to grit and contaminants contained in the water which will foul the servo operation, and render the unit inefficient or inoperative. Finally, the nature of hydraulically driven units requires the use of many water tight seals that can resist household water line pressures, including the severe pressure spikes caused by the quick closing valves of washing machines and dishwashing machines. The natural variations in manufacturing, assembly and installation result in a greater risk of pressure leaks.

### SUMMARY OF THE INVENTION

It has been recognized that it would be advantageous to develop a waste disposal unit that overcomes many of the disadvantages outlined above. In addition, it has been recognized that it would be advantageous to develop a waste disposal unit that requires lower power input, is resistant to jamming, and has a high mechanical advantage for cutting waste and has a replaceable electric motor relieving the need to replace the entire food waste disposer in the event of motor failure.

The invention provides a waste disposal apparatus with an electric motor operatively coupled to reciprocally pivot a pivoting cutter. Therefore, the apparatus can operate independent of available water pressure, and can reverse the direction of the pivoting cutter due to a jam condition. The apparatus has a plurality of cutters including a pivoting cutter pivotally disposed adjacent a stationary cutter.

In accordance with a more detailed aspect of the present invention, the cutters each have a plurality of spaced apart teeth, formed on arms extending radially from a hub, which intermesh as the pivoting cutter pivots. The cutters each have at least one tooth with an edge, which passes adjacent the other as the pivoting cutter pivots. Each edge is angled towards the other in a direction of rotation configured to concentrate force at a single point along the edges as the edges pass one another.

In accordance with another more detailed aspect of the present invention, at least one of the cutters includes a primary tooth with a primary edge forming an acute angle with respect to a primary arm. The other one of the cutters includes a secondary tooth with a secondary edge forming an obtuse angle with respect to a secondary arm. The edges of the teeth preferably form an acute angle with respect to one another.

In accordance with a more detailed aspect of the present invention, the motor is disposed at a side of the cutters, and off a longitudinal axis, which extends between an inlet and an outlet. The pivoting and stationary cutters can be disposed in a housing, and the motor can be disposed outside the housing. Preferably, the motor is disposed at an elevation above a lowermost cutter, and/or at an elevation above the outlet of a housing containing the cutters. Therefore, the apparatus can be configured to take advantage of gravity and the natural flow of water in a vertically downward direction, while locating the electric motor away from potential water leaks.

In accordance with a more detailed aspect of the present invention, the pivoting cutter and motor have non-concentric axes of rotation. In addition, the motor engages a perimeter of the pivoting cutter or connected gear. The motor can have a rotatable drive member engaging the pivoting cutter or connected gear. In addition, the pivoting cutter can have a diameter greater than a diameter of the drive member of the motor. Therefore, the location of the motor to engage the perimeter of the pivoting cutter can provide a mechanical advantage of increasing the torque, reducing the necessary size of the motor, and resisting wear on the motor.

In accordance with a more detailed aspect of the present invention, the motor has a shaft, which is indirectly coupled to the pivoting cutter. A gear interface can be inter-coupled between the motor and the pivoting cutter. Again, torque can be multiplied while reducing the necessary size of the motor and resisting wear on the motor.

In accordance with a more detailed aspect of the present invention, the motor is configured to pivot the pivoting cutter at less than approximately 50 cycles per minute, and more preferably less than approximately 20 cycles per minute. Such a reduced or lower speed prevents the waste from being flung radially outwardly by the cutters, allows a majority of the cutter to be used, as opposed to just the outer ends, and reduces the noise of the motor, and takes advantage of gravity to move the food waste down through the disposal.

In accordance with a more detailed aspect of the present invention, the motor itself is reversible to reciprocally pivot the pivoting cutter in two directions. Therefore, the motor and cutters can reverse direction in response to a jam condition between the cutters.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a cross sectional side view of a waste disposal apparatus in accordance with the present invention;

FIG. 2 is a partial cross sectional side view of the waste disposal apparatus of FIG. 1;

FIG. 3 is an exploded view of a cutter stack in accordance with the present invention;

FIG. 4 is a perspective view of a stationary secondary cutter in accordance with the present invention;

FIG. 5 is a perspective view of a pivoting primary cutter in accordance with the present invention;

FIG. 6 is a partial cross sectional side view of the primary and secondary cutters of FIGS. 5 and 6; and

FIG. 7 is a cross sectional side view of another waste disposal apparatus in accordance with the present invention.

### DETAILED DESCRIPTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

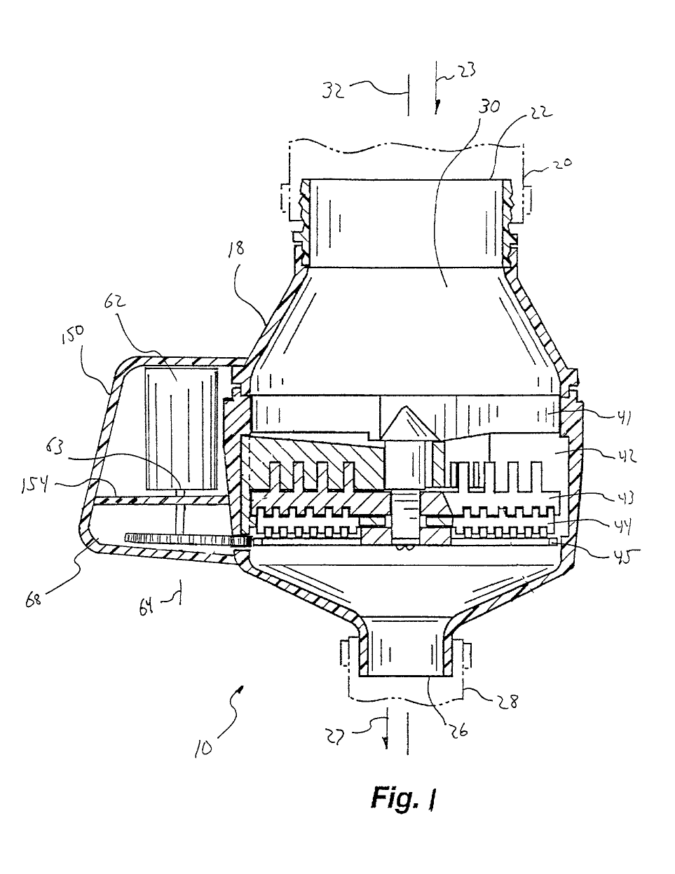

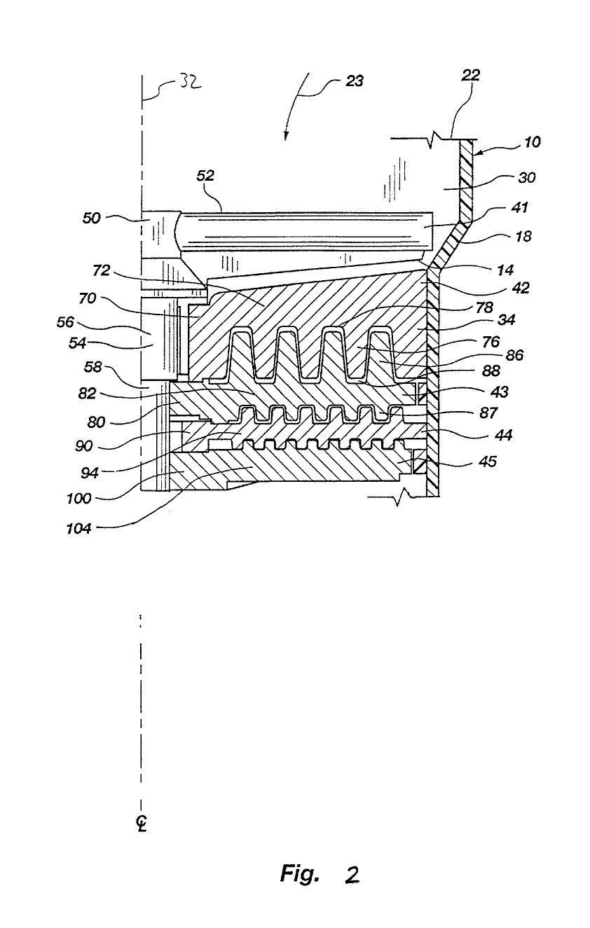

As illustrated in FIGS. 1 and 2, a waste disposal apparatus, indicated generally at 10, in accordance with the present invention is shown for cutting or commuting waste, and advantageously includes a specific cutter configuration driven in a reciprocal manner by an electric motor, as described in greater detail below. Waste disposals for sinks or kitchens are one example of a field that may benefit from use of such a waste disposal apparatus 10. In addition, automatic dishwashers are another field that may benefit from such a waste disposal apparatus 10.

The waste disposal apparatus 10 has an apparatus housing 18 adapted for being disposed under a sink or with an automatic dishwasher, indicated in phantom lines at 20. The housing has a first end or top, and a second end or bottom. The housing 18 has a waste inlet 22 disposed at the first end for allowing the waste and water into the housing 18, indicated by arrow 23. The housing 18 and/or inlet 22 may be configured for being coupled to a drain of a sink or to an automatic dishwasher 20. The housing 18 also has an outlet 26 disposed at the second end for allowing the waste and water out of the housing 18, indicated by arrow 27. The outlet 26 can be configured for being coupled to a plumbing system or drain line, indicated in phantom lines at 28. Preferably, the inlet 22 and outlet 26 are vertically oriented, or the inlet 22 is configured to receive waste and water in a vertically downward direction, while the outlet 26 is configured to drain waste and water in a vertically downward direction.

The housing 18 also has a waste passage 30 formed therein and extending between the waste inlet 22 and the outlet 26. The housing 18 or passage 30 can have a longitudinal axis 32 extending between the first and second ends of the housing. The longitudinal axis 32 and waste passage 30 preferably are oriented vertically and straight to facilitate the flow of waste and water through the housing 18 or passage 30. Thus, the passage 30 is oriented to take advantage of the natural flow direction of the water due to gravity. Preferably, the passage 30 has a circular cross sectional shape.

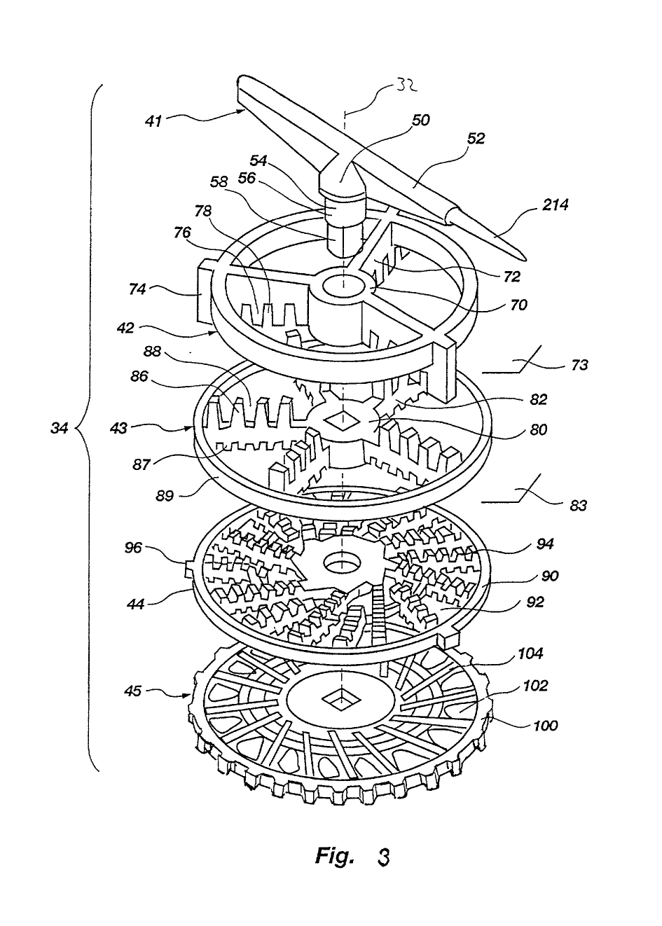

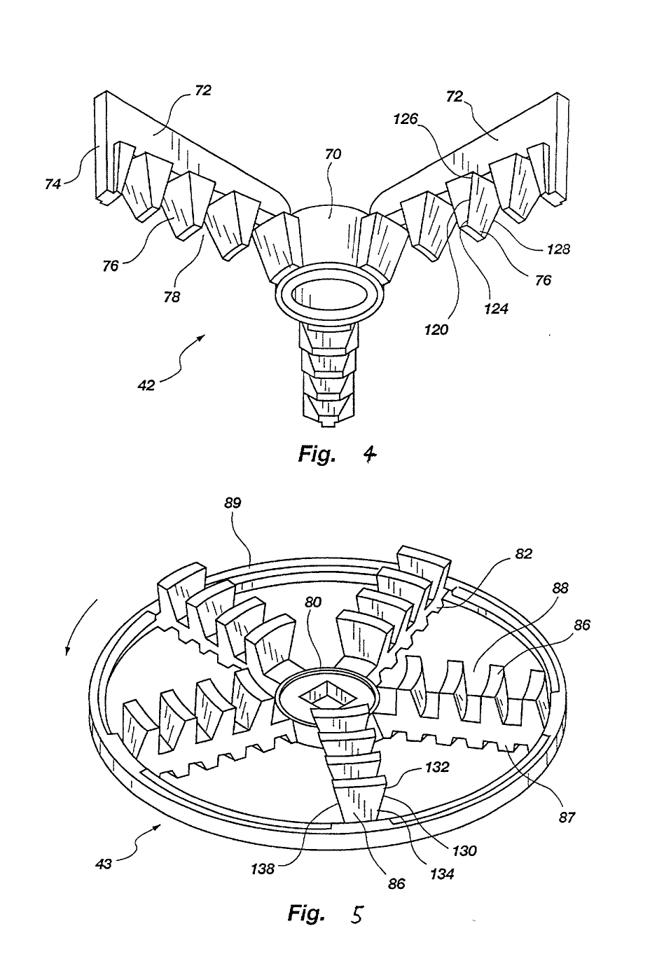

A plurality of cutters or a cutter stack 34 is disposed in the passage 30 for cutting or shredding the waste as the waste passes through the passage 30. The cutters 34 may be associated together in layers, or stacks. Referring to FIGS. 1-3, the cutters 34 may include a plurality of cutters with different configurations. In addition, the cutters 34 can include both stationary and pivoting cutters.

The plurality of cutters 34 may include a first pivoting cutter 41, a second stationary cutter 42, a third pivoting cutter 43, a fourth stationary cutter 44, and a fifth pivoting cutter 45. It is of course understood that any number of cutters could be employed and that the above five cutters are exemplary only. Alternating cutters can be configured to pivot or remain stationary. For example, the first cutter 41, third cutter 43, and fifth cutter 45 may pivot, or can be pivoting cutters. The second cutter 42 and fourth cutters 44 can remain stationary, or can be stationary cutters. It is of course understood that the arrangement of pivoting and stationary cutter can be reversed. The cutters 34 can be configured to intermesh and/or pivot adjacent one another to provide a cutting action. In addition, the cutters 34 can have specific characteristics to facilitate cutting, as described in greater detail below.

The pivoting cutters 41, 43 and 45 pivot about a pivot axis that preferably is parallel or collinear with the longitudinal axis 32. In addition, the cutters 34 preferably are oriented transverse or perpendicular to the longitudinal axis 32, and the passage 30. Thus, the cutters 34 can commute the waste as it passes through the passage 30.

As stated above, the cutters 34 can include a plurality of cutters arranged in a stack. The first cutter 41 has first hub 50 disposed at the longitudinal axis 32, and can be pivotally disposed in the passage 30. The first cutter 41 also has a shaft 54 extending from the first hub 50 along the longitudinal axis 32. The shaft 54 may have circular portions 56, or bearing portions, and square portions 58, or key portions. The square or key portions 58 are located along the shaft at locations corresponding to other pivoting cutters, or the third and fifth cutters 43 and 45, while the circular or bearing portions 58 are located at locations corresponding to stationary cutters, or the second and fourth cutters 42 and 44. The third and fifth cutters 43 and 45 engage the shaft 54 of the first cutter 41 so that the pivoting cutters pivot together. The circular or bearing portions 58 of the shaft 54 allow the shaft to pivot with respect to the stationary cutters 42 and 44.

As stated above, the waste disposal apparatus 10 advantageously includes an electric motor 62 operatively coupled to the pivoting cutters 41, 43 and 45. Preferably, the electric motor 62 reciprocally pivots the pivoting cutters 41, 43 and 45, as opposed to continually rotating. Thus, the waste disposal apparatus 10, or pivoting cutters 41, 43 and 45 can reverse direction in response to waste causing a jam between the cutters 34, unlike typical electric powered waste disposal units that rotate in a single direction. In addition, the waste disposal apparatus 10 advantageously is unaffected by variations in water supply pressure, and is capable of operation in locations of low water pressure.

Preferably, the motor 62 advantageously is disposed at a side of the cutters 34 or cutter stack, and off the longitudinal axis 32. The motor 62 can be disposed outside the housing 18, or at least outside a portion of the housing forming the passage 30. In addition, the motor 62 preferably and advantageously is disposed at an elevation above a lowermost cutter, or the fifth cutter 45, and/or above the outlet 26 of the housing 18. As stated above, the passage 30, or inlet 22 and outlet 26, is oriented vertically to take advantage of gravity and the natural flow of water in a vertically downward direction. Therefore, the electric motor 62 advantageously is not located under the cutters 34 and passage 30, and thus is less susceptible to water that might leak from the passage 30.

The electric motor 62 includes a motor shaft 63 with an axis of rotation 64. Preferably, the shaft 63 of the motor 62 is not directly coupled to the cutter shaft 54 of the pivoting cutters 41, 43 and 45. In addition, the pivoting cutters 41, 43 and 45 and the motor 62 preferably have non-concentric axes of rotation 64 and 32, respectively. The electric motor 62 advantageously can engage an outer periphery of one of the pivoting cutters, such as the fifth pivoting cutter 45. For example, the outer perimeter of one of the pivoting cutters, such as the fifth pivoting cutter 45, can have a toothed edge, or a gear-like configuration, with a plurality of gear teeth. The motor shaft 63 can be provided with a rotatable drive member 66 having a similar toothed edge, or a gear-like configuration, with a plurality of gear teeth that intermesh with the gear teeth of the fifth pivoting cutter 45. It is of course understood that the motor 62 may engage the pivoting cutter 45 directly, as shown, or may engage a separate gear member attached to the pivoting cutter.

Preferably, the rotatable drive member or shaft of the motor 62 has a smaller diameter than a diameter of the fifth pivoting cutter 45. Thus, the waste disposal apparatus 10 advantageously applies the power of the electric motor 62 to the outside diameter of one of the pivoting cutters, rather than at the center or cutter shaft of the cutters. Therefore, a smaller electric motor is needed, and wear on the motor is reduced. The apparatus 10 preferably utilizes a motor with less than approximately ¼ horsepower, and more preferably with approximately ⅛ horsepower.

In addition, the motor shaft 63 of the motor 62 can be indirectly coupled to the pivoting cutters 41, 43 and 45, such as by a gear interface, indicated generally at 68, as shown in FIG. 7. The gear interface 68 (FIG. 7) is inter-coupled between the motor 62 and the pivoting cutter, such as fifth pivoting cutter 45. The gear interface 68 can include a plurality of gears with various different diameters, which may be configured to further increase the torque delivered by the motor, and/or to decrease the speed of the motor.

Indirectly coupling the motor 62 to the pivoting cutters, and/or engaging a perimeter of the pivoting cutters rather than the cutter shaft, also makes the apparatus 10 easier to service. For example, if the motor 62 fails, it is easily replaced without replacing the entire apparatus.

The pivoting cutters 41, 43 and 45 are configured to operate or pivot at significantly reduced speeds, or cycles per minute. As used herein, the term “cycles per minute” (cpm) is similar to revolutions per minute (rpm), except that it is understood that the cutters may not complete a full revolution due to the reciprocating nature of the cutters. The pivoting cutters 41, 43 and 45 preferably pivot at less than 50 cpm, more preferably less than 20 cpm, and most preferably at approximately 15 cpm. As stated above, typical prior art, electrically driven waste disposal units have speeds between 2,000 to 8,000 rpm. Thus, the lower speed of the waste disposal apparatus 10 advantageously tends to result in waste being processed in a vertically downward direction through the cutters 34, rather than being thrashed or flung outwardly in a radial direction against the housing. In addition, the lower speeds tend to result in considerably less noise. The low speed of the pivoting cutters can be accomplished by using an electric motor that has a lower speed, and/or by using the gear interface. As stated above, the outer perimeter of the pivoting cutters can be large with respect to the shaft or rotatable drive member of the motor.

The cutters 34 can be arranged to sequentially commute reduced sizes of waste, with the first cutters encountered by the waste being arranged with fewer and larger openings for larger waste, and the last cutters encountered by the waste being arranged with more and smaller openings for smaller waste which was commuted by the first cutters. For example, the first pivoting cutter 41 has a first pair of arms 52 extending radially from the hub 50, or generally perpendicularly to the axis 32. Thus, two large opening or gaps are formed between the arms 52.

The second stationary cutter 42 also is referred to herein as a primary cutter, and the third pivoting cutter also is referred to herein as a secondary cutter, for purposes of describing the configuration of the teeth below. It is of course understood that any of the cutters 34 may be designated as the primary or secondary cutter, or that any of the cutters 34 can have the configuration of the teeth as described with respect to the primary and secondary cutters, or the second and third cutters.

The second stationary cutter 42 can have a primary hub 70, or stationary hub, disposed at the longitudinal axis 32, and about the cutter shaft 54 so that the cutter shaft 54 can pivot with respect to the second cutter 42. The second cutter 42 has a plurality of primary arms 72, or stationary arms, extending outwardly in a radial direction from the hub 70, or generally perpendicularly to the axis 32. Preferably, the second cutter 42 has three arms 72 forming three gaps therebetween, and that pass adjacent to the arms 52 of the first cutter 41 to initially commute waste, or larger waste. The primary arms 72 define a primary plane 73 along which the arms extend, or a primary layer in which the arms extend, which is perpendicular to the longitudinal axis 32. The second cutter 42 is fixedly disposed in the passage 30, or is stationary, and has a tab 74 for engaging a notch (not shown) formed in the passage 30 to prevent the second cutter 42 from rotating.

The primary hub 70 of the second cutter 42 has a bore therein through which the cutter shaft 54 passes. The bore is circular and receives a circular portion 56 of the shaft 54 so that the shaft 54 may rotate freely with respect to the primary hub 70. As the first cutter 41 rotates with respect to the second cutter 42, the first arm 52 passes adjacent the plurality of primary arms 72, cutting waste therebetween.

A plurality of primary teeth 76 are disposed or formed on the primary arms 72. The primary teeth 76 are spaced apart or staggered along the primary arms 72. The primary teeth 76 extend from the arms 72 towards the third (or secondary) cutter 43. The primary teeth 76 define primary spaces or grooves 78 therebetween.

The third pivoting cutter 43 can have a secondary hub 80, or pivoting hub, disposed at the longitudinal axis 32. The third cutter 43 has a plurality of secondary arms 82, or pivoting arms, extending outwardly in a radial direction from the hub 80, or generally perpendicularly to the axis 32. Preferably, the third cutter 43 has five arms 82 forming five gaps therebetween, and passing adjacent the arms 72 of the second cutter 42 to commute waste. The secondary arms 82 define a secondary plane 83 along which the arms extend, or a secondary layer in which the arms extend, which is perpendicular to the longitudinal axis 32 and parallel with the primary plane 73. The secondary cutter 43 is pivotally or rotatably disposed in the passage 30.

The secondary hub 80 of the third cutter 43 has a bore therein through, which the shaft 54 passes. The bore is square and receives a square portion 58 of the shaft 54 so that the hub 80 rotates with the shaft 54. Thus, the first and third cutters 41 and 43 pivot with respect to the second cutter 42. It is of course understood that the shaft 54 and third cutter 43 may be coupled or keyed in any suitable manner.

A plurality of secondary teeth 86 are disposed or formed on the secondary arms 82. The secondary teeth 86 are spaced apart or staggered along the secondary arms 82. The secondary teeth 86 extend from the arms 82 towards the second or primary cutter 42. The secondary cutter 43 may also have a plurality of teeth 87 extending away from the primary cutter 42. The secondary teeth 86 define secondary spaces or grooves 88 therebetween.

The primary and secondary teeth 76 and 86 intermesh as the secondary or third cutter 43 pivots with respect to the primary or second cutter 42. The primary teeth 76 extend into the secondary spaces 88, while the secondary teeth 86 extend into the primary spaces 78. As the secondary or third cutter 43 pivots, waste is cut between the primary and secondary teeth 76 and 86, and between the primary and secondary arms 72 and 82. The waste passes between the plurality of primary arms 72 and between the plurality of secondary arms 82 where it is cut as the secondary teeth 86 pass by the primary teeth 76.

The secondary cutter 43 may have an annular support member 89 formed around the periphery of the cutter to support the secondary arms 82. The secondary arms 82 extend from the hub 80 to the support member 89.

The fourth stationary cutter 44 can have a circular plate 90 with a plurality of openings 92 formed therein through which the waste may pass. The openings 92 can be defined by arms 94 that are formed in the plate 90. The fourth cutter 44 is fixedly disposed in the passage 30, or is stationary, and has a tab 96 for engaging a notch (not shown) formed in the passage 30 to prevent the fourth cutter 44 from rotating. A plurality of teeth are formed on the fourth cutter 44, or on the arms 94. The plate 90 may have a bore therein through, which the shaft 54 passes. The bore is circular and receives a circular portion 56 of the shaft 54 so that the shaft 54 may rotate freely with respect to the plate.

The fifth pivoting cutter 45 also can have a circular plate 100 with a plurality of openings 102 formed therein through which the waste may pass. The openings 102 may be defined by arms 104 formed in the plate 100. A plurality of cutters are disposed on the fifth cutter 45, or on the arms 104. The fifth cutter 45 has a bore therein through, which the shaft 54 passes. The bore is square and receives a square portion 58 of the shaft 54 so that the fifth cutter 45 rotates with the shaft 54. Thus, the first cutter 41, third cutter 43, and fifth cutter 45 rotate with respect to the second and fourth cutters 42 and 44.

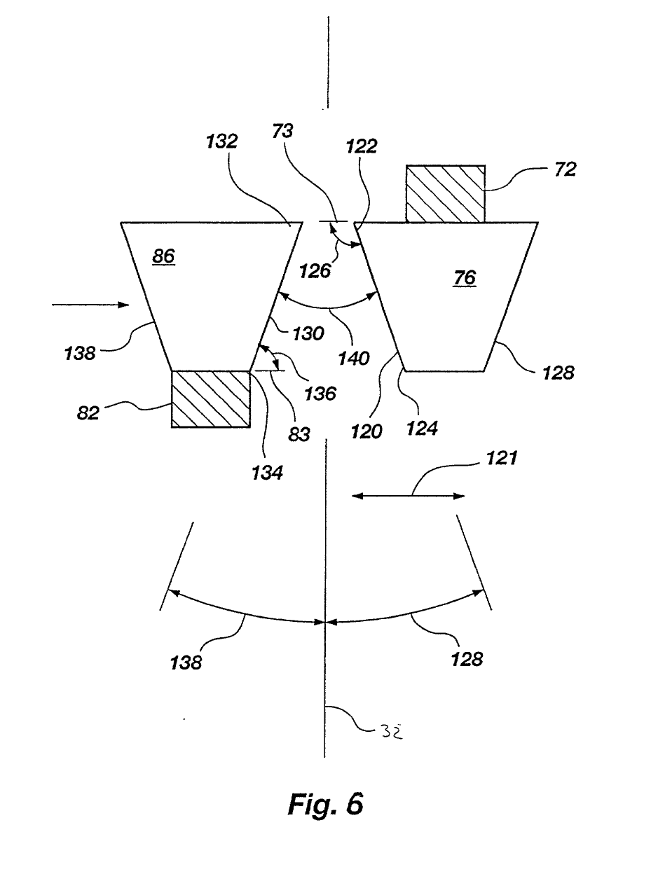

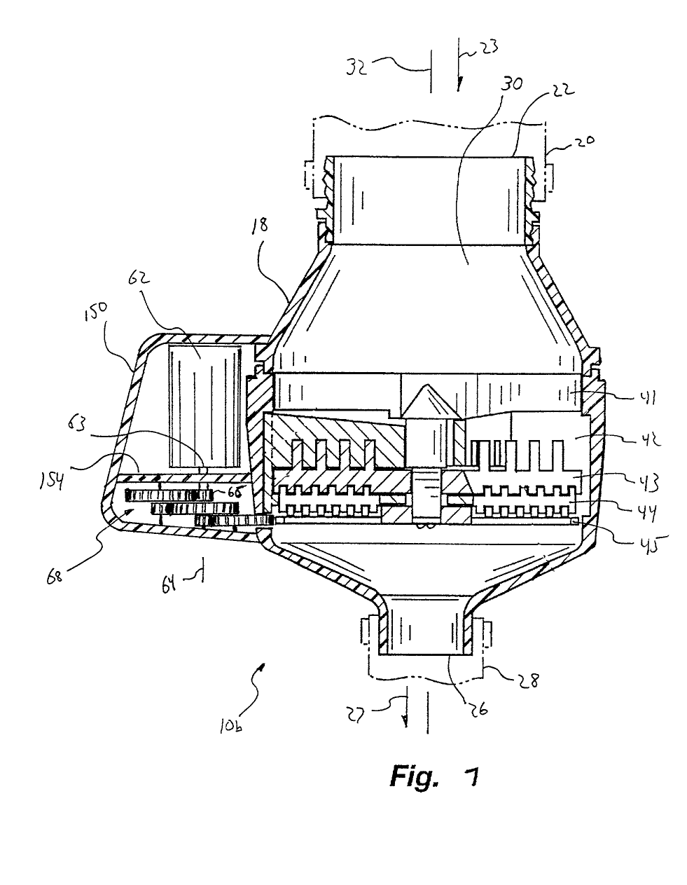

Referring to FIG. 6, the primary teeth 76 have a primary edge 120, or first primary edge. The primary edge 120 generally faces or extends towards the secondary teeth 86 as the secondary teeth approach the primary teeth 76 during rotation of the secondary cutter 43. The primary edge 120 advantageously is angled with respect to the secondary teeth 86. The primary edge 120 is oriented with respect to the primary arm 72, or primary plane, to form an obtuse angle, indicated at 126. The primary edge 120 preferably forms an angle 126 with respect to the primary plane 73 of approximately 97 degrees, or an angle 128 with respect to the longitudinal axis 32 of approximately 7 degrees. The primary edge 120 has a leading end 122 and a trailing end 124. The leading end 122 of the primary edge 120 encounters the secondary teeth 86 first. The primary edge 120 may also be a primary surface.

Similarly, the secondary teeth 86 have a secondary edge 130, or first secondary edge. The secondary edge 130 generally faces or extends towards the primary teeth 76 as the secondary teeth 86 approach the primary teeth 76 during rotation of the secondary cutter 43. The secondary edge 130 advantageously is angled with respect to the primary teeth 76. The secondary edge 130 is oriented with respect to the secondary arm 82, or secondary plane, to form an acute angle, indicated at 128. The secondary edge 130 preferably forms an angle 136 with respect to the secondary plane of approximately 83 degrees, or an angle 138 with respect to the longitudinal axis 32 of approximately 7 degrees. The secondary edge 130 has a leading end 132 and a trailing end 134. The leading end 132 of the secondary edge 120 encounters the primary teeth 76 first. The secondary edge 130 may also be a secondary surface.

As shown in FIG. 6, a secondary tooth 86 approaches an adjacent primary tooth 76 as the secondary cutter 43 rotates, or during relative rotation of the two cutters. The primary and secondary teeth 76 and 86, or the primary and secondary edges 120 and 130, advantageously extend towards, or generally face towards, each other as the secondary cutter 43 rotates forming an angle with respect to each other, indicated at 140. The primary and secondary edges 120 and 130 are preferably oriented with respect to one another to form an angle 140 of approximately 14 degrees.

The leading ends 122 and 132 of the primary and secondary teeth 76 and 86 advantageously met first as the secondary cutter 43 rotates with respect to the primary cutter 42. Thus, force applied to the waste by the motor, and the cutters, is concentrated at a point on the teeth, rather than all along the teeth. As the cutter rotates, the force applied along a single point that moves along the edge of the teeth from the leading end to the trailing end, rather than along the entire length of the teeth all at once. Thus, the force is concentrated and is better able to cut.

The secondary cutter 43 may rotate in either direction. Therefore, the primary and secondary teeth 76 and 86 have an opposite primary edge 128 and an opposite secondary edge 138, respectively. The opposite primary edge 128 is opposite the first primary edge 120. Likewise, the opposite secondary edge 138 is opposite the first secondary edge 130. The opposite edges 128 and 138 are similar to their counterpart edges 120 and 130, respectively. Thus, if the secondary cutter 43 rotates in an opposite direction, the opposite secondary edge 138 meets the opposite primary edge 128. The opposite edges 128 and 138 may be oriented at different angles than the first primary edge and first secondary edge 120 and 130.

Because the edges 120 and 130 are oriented such that they face downstream, or towards the outlet, any waste which is not cut by the teeth, but propelled away from the teeth because of the angled edges, is propelled towards the outlet and not towards the inlet, thus avoiding potential injury to a user. The edges 120 and 130, however, may be oriented to face upstream, or towards the inlet.

As discussed above, the particular configuration and operation of the cutters 34 and the electric motor 62 operate synergistically to provide numerous advantages and more efficient operation of the waste disposal apparatus 10. Locating the electric motor 62 out from under the passage 30 and cutters 34, and engage the perimeter of the cutters with the motor, improves the gravity assisted flow of the apparatus, naturally directs flow of water away from the motor, improves dependability of, and reduces wear on, the motor, reduces the speed of the cutters and motors, reduces the noise produced by the motor, allows comminuting of waste across the entire cutter, including the inner portions, increases the power or torque of the cutters, reduces the necessary motor size, reduces stalling, eliminates dependence on water pressure, etc.

Referring again to FIG. 1, the motor 62 preferably is disposed outside the housing 18, or at least a portion of the housing 18 forming the passage 30. The apparatus 10 or housing 18 can include a motor housing 150 in which the motor 62 is disposed. The motor housing 150 can attach to, or be formed with, the housing 18. In addition, a seal or barrier 154 can be formed between the motor 62 and the passage 30, the motor 62 and the cutters 34, and/or the motor 62 and the gear interface 68, to further resist water from reaching the electrical conductors of the motor 62.

As stated above, the electric motor 62 advantageously pivots the cutters 41, 43 and 45 in a reciprocating manner. Preferably, the motor 62 pivots the cutters 41, 43 and 45 in one direction ranging from a partial rotation, to several rotations. If any waste becomes lodged between the cutters 34, the cutters 41, 43 and 45 preferably reverse direction. The reciprocating pivoting of the cutters 41, 43 and 45 can be accomplished in different ways. Similarly, the lodge or jam condition of the cutters 34 can be sensed in different ways. For example, the electrical motor 62 can be reversible in order to reverse the direction of the cutters 41, 43 and 45, and pivot the cutters in two directions. Alternatively, the motor 62 may be unidirectional, and the reverse direction may be accomplished through a gear interface, with different gears or gear sets engaging the cutters depending on the desired direction of rotation.

In addition, the lodge or jam condition of the cutters 34 may be sensed by sensing a stall condition of the motor 62. For example, a controller or electronics can be coupled to the motor to sense various electrical properties or conditions associated with the stall condition of the motor. For example, the controller or electronics may sense, detect, or generate a time or clock signal, and thus automatically reverse the direction of the motor at predetermined times. As another example, the controller or electronics may sense or detect a power spike, or change in amperage or current, which may indicate a jam condition. Similarly, the controller or electronics may sense or detect a decrease in motor speed, which may indicate a jam condition. Such a controller or electronics can be directly coupled to the motor, or electrical power supply of the motor, to sense or detect such conditions. Alternatively, separate sensors may be used to sense various conditions.

Although the apparatus 10 has been described above and illustrated with a gear, or gear-like, interface between the motor 62 and pivoting cutter 45, it is of course understood that the motor 62 can operatively engage the pivoting cutters in any manner, including for example, with a belt and pulleys, a chain drive, a friction drive, etc.

Referring to FIG. 7, another waste disposal apparatus 10b is shown which is similar in most respects to the apparatus 10 described above, but includes the gear interface 68, as described above.

It is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been shown in the drawings and fully described above with particularity and detail in connection with what is presently deemed to be the most practical and preferred embodiment(s) of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A waste disposal apparatus, comprising:
a) a pivoting cutter pivotally disposed adjacent a stationary cutter, each cutter having a plurality of spaced apart teeth, formed on arms extending radially from a hub, which intermesh as the pivoting cutter pivots;
b) the cutters each having at least one tooth with an edge which passes adjacent the other as the pivoting cutter pivots, each edge being angled towards the other in a direction of rotation configured to concentrate force at a single point along the edges as the edges pass one another; and
c) an electric motor operatively coupled to the pivoting cutter so as to reciprocally pivot the pivoting cutter.

2. An apparatus in accordance with claim 1,
a) wherein at least one of the cutters includes a primary tooth with a primary edge forming an acute angle with respect to a primary arm; and
b) wherein the other one of the cutters includes a secondary tooth with a secondary edge forming an obtuse angle with respect to a secondary arm.

3. An apparatus in accordance with claim 1, wherein the edges of the teeth form an acute angle with respect to one another.

4. An apparatus in accordance with claim 1, wherein the motor is disposed at a side of the cutters, and off a longitudinal axis which extends between an inlet and an outlet.

5. An apparatus in accordance with claim 1, wherein the pivoting and stationary cutters are disposed in a housing; and wherein the motor is disposed outside the housing.

6. An apparatus in accordance with claim 1, wherein the motor is disposed at an elevation above a lowermost cutter.

7. An apparatus in accordance with claim 1, wherein the motor is disposed at an elevation above the outlet of a housing containing the cutters.

8. An apparatus in accordance with claim 1, wherein the pivoting cutter and motor have non-concentric axes of rotation.

9. An apparatus in accordance with claim 1, wherein the motor engages a perimeter of the pivoting cutter.

10. An apparatus in accordance with claim 1,
a) wherein the motor has a rotatable drive member engaging the pivoting cutter; and
b) wherein the pivoting cutter has a diameter greater than a diameter of the drive member of the motor.

11. An apparatus in accordance with claim 1, wherein the motor has a shaft which is indirectly coupled to the pivoting cutter.

12. An apparatus in accordance with claim 1, further comprising:
a gear interface, inter-coupled between the motor and the pivoting cutter, such that the motor and pivoting cutter are indirectly coupled.

13. An apparatus in accordance with claim 1, wherein the motor is configured to pivot the pivoting cutter at less than approximately 50 cycles per minute.

14. An apparatus in accordance with claim 1, wherein the motor has less than approximately ¼ horse power.

15. An apparatus in accordance with claim 1, wherein the motor is reversible to reciprocally pivot the pivoting cutter in two directions.

16. An apparatus in accordance with claim 1, further comprising an inlet coupled to a drain of a sink.

17. An apparatus in accordance with claim 1, further comprising an inlet coupled to an automatic dishwasher.

18. A waste disposal apparatus, comprising:
a) a pivoting cutter pivotally disposed adjacent a stationary cutter and aligned along a longitudinal axis between an inlet and an outlet;
b) an electric motor operatively coupled to the pivoting cutter so as to reciprocally pivot the pivoting cutter; and
c) the motor being disposed at a side of the cutters, and off the longitudinal axis.

19. An apparatus in accordance with claim 18, wherein the pivoting and stationary cutters are disposed in a housing; and wherein the motor is disposed outside the housing.

20. An apparatus in accordance with claim 18, wherein the motor is disposed at an elevation above a lowermost cutter.

21. An apparatus in accordance with claim 18, wherein the motor is disposed at an elevation above the outlet of a housing containing the cutters.

22. An apparatus in accordance with claim 18, wherein the pivoting cutter and motor have non-concentric axes of rotation.

23. An apparatus in accordance with claim 18, wherein the motor engages a perimeter of the pivoting cutter.

24. An apparatus in accordance with claim 18,
a) wherein the motor has a rotatable drive member engaging the pivoting cutter; and
b) wherein the pivoting cutter has a diameter greater than a diameter of the drive member of the motor.

25. An apparatus in accordance with claim 18, wherein the motor has a shaft which is indirectly coupled to the pivoting cutter.

26. An apparatus in accordance with claim 18, further comprising:
a gear interface, inter-coupled between the motor and the pivoting cutter, such that the motor and pivoting cutter are indirectly coupled.

27. An apparatus in accordance with claim 18, wherein the cutters each having at least one tooth, disposed on an arm extending from a hub, with an edge which passes adjacent the other as the pivoting cutter pivots, each edge being angled towards the other in the direction of rotation configured to concentrate force at a single point along the edges as the edges pass one another.

28. An apparatus in accordance with claim 18, wherein the cutters each have a plurality of spaced apart teeth, formed on an arm extending radially from a hub, which intermesh as the pivoting cutter pivots.

29. An apparatus in accordance with claim 18, wherein the motor is configured to pivot the pivoting cutter at less than approximately 50 cycles per minute.

30. An apparatus in accordance with claim 18, wherein the motor has less than approximately ¼ horse power.

31. An apparatus in accordance with claim 18, wherein the motor is reversible to reciprocally pivot the pivoting cutter in two directions.

32. An apparatus in accordance with claim 18, wherein the inlet is coupled to a drain of a sink.

33. An apparatus in accordance with claim 18, wherein the inlet is coupled to an automatic dishwasher.

34. A waste disposal apparatus, comprising:
a) a pivoting cutter pivotally disposed adjacent a stationary cutter;
b) an electric motor operatively coupled to the pivoting cutter so as to reciprocally pivot the pivoting cutter; and
c) the motor being configured to pivot the pivoting cutter at less than approximately 50 cycles per minute.

35. An apparatus in accordance with claim 34, wherein the motor is configured to pivot the pivoting cutter at less than approximately 20 cycles per minute.

36. An apparatus in accordance with claim 34, wherein the motor has less than approximately ¼ horse power.

37. An apparatus in accordance with claim 34, wherein the cutters each having at least one tooth, disposed on an arm extending from a hub, with an edge which passes adjacent the other as the pivoting cutter pivots, each edge being angled towards the other in the direction of rotation configured to concentrate force at a single point along the edges as the edges pass one another.

38. An apparatus in accordance with claim 34, wherein the cutters each have a plurality of spaced apart teeth, formed on an arm extending radially from a hub, which intermesh as the pivoting cutter pivots.

39. An apparatus in accordance with claim 34, further comprising an inlet coupled to a drain of a sink.

40. An apparatus in accordance with claim 34, further comprising an inlet coupled to an automatic dishwasher.

41. A waste disposal apparatus, comprising:
a) a pivoting cutter pivotally disposed adjacent a stationary cutter;
b) an electric motor operatively coupled to the pivoting cutter so as to reciprocally pivot the pivoting cutter; and
c) the motor being reversible to reciprocally pivot the pivoting cutter in a reverse direction in response to a condition where waste is jammed between the pivoting and stationary cutters.

42. An apparatus in accordance with claim 41, wherein the motor is reversible before a complete cycle.

43. An apparatus in accordance with claim 41, wherein the cutters each having at least one tooth, disposed on an arm extending from a hub, with an edge which passes adjacent the other as the pivoting cutter pivots, each edge being angled towards the other in the direction of rotation configured to concentrate force at a single point along the edges as the edges pass one another.

44. An apparatus in accordance with claim 41, wherein the cutters each have a plurality of spaced apart teeth, formed on an arm extending radially from a hub, which intermesh as the pivoting cutter pivots.

45. An apparatus in accordance with claim 41, further comprising an inlet coupled to a drain of a sink.

46. A waste disposal apparatus configured to be coupled between a source of waste and water and a drain system, the apparatus comprising:
a) a housing having an inlet and an outlet vertically aligned along a longitudinal axis;
b) a cutter stack, disposed in the housing along the longitudinal axis, including a pivoting cutter pivotally disposed adjacent a stationary cutter, each cutter having arms extending radially from a hub;
c) the cutters each having at least one tooth, disposed on the arms, with an edge which passes adjacent the other as the pivoting cutter pivots, each edge being angled towards the other in the direction of rotation configured to concentrate force at a single point along the edges as the edges pass one another;
d) an electric motor operatively coupled to the pivoting cutter so as to reciprocally pivot the pivoting cutter;
e) the motor being disposed at a side of the cutter stack, and off the longitudinal axis; and
f) the motor being configured to pivot the pivoting cutter at less than approximately 50 cycles per minute.

47. An apparatus in accordance with claim 46, wherein the motor is disposed outside the housing.

48. An apparatus in accordance with claim 46,
a) wherein the motor is disposed at an elevation above a lowermost cutter; and
b) wherein the motor is disposed at an elevation above the outlet of the housing.

49. An apparatus in accordance with claim 46, wherein the motor engages a perimeter of the pivoting cutter.

50. An apparatus in accordance with claim 46,
a) wherein the motor has a rotatable drive member engaging the pivoting cutter; and
b) wherein the pivoting cutter has a diameter greater than a diameter of the drive member of the motor.

51. An apparatus in accordance with claim 46, further comprising:
a gear interface, inter-coupled between the motor and the pivoting cutter, such that the motor and pivoting cutter are indirectly coupled.

52. An apparatus in accordance with claim 46, wherein the motor is configured to pivot the pivoting cutter at less than approximately 20 rpm.

53. An apparatus in accordance with claim 46, wherein the motor has less than approximately ¼ horse power.

54. An apparatus in accordance with claim 46, wherein the motor is reversible to reciprocally pivot the pivoting cutter in two directions.

55. An apparatus in accordance with claim 46, wherein the inlet is coupled to a drain of a sink.

56. An apparatus in accordance with claim 46, wherein the inlet is coupled to an automatic dishwasher.
